(19) United States
(12) Patent Application Publication
(10) Pub. No.: US 2014/0355645 A1
(43) Pub. Date: Dec. 4, 2014

(54) METHOD AND APPARATUS FOR MEASURING SEDIMENTATION OF SOLID-LIQUID TWO-PHASE MIXTURE

(71) Applicant: Wuhan University of Technology, WUHAN CITY (CN)

(72) Inventors: HAIBIN CHENG, WUHAN CITY (CN); CHAOSHENG LIU, WUHAN CITY (CN); QINGJIE ZHANG, WUHAN CITY (CN); WENTAO MA, WUHAN CITY (CN); YAWEN DAI, WUHAN CITY (CN)

(73) Assignee: Wuhan University of Technology, WUHAN CITY (CN)

(21) Appl. No.: 14/273,651

(22) Filed: May 9, 2014

(30) Foreign Application Priority Data
May 29, 2013 (CN) 201310207325

(51) Int. Cl. G01N 25/18

(52) U.S. Cl. CPC G01N 25/18
USPC 374/44

(57) ABSTRACT

A method and an apparatus for measuring sedimentation of a solid-liquid two-phase mixture are provided. A standard work curve and/or standard mathematical model, indicating a relationship between thermal conductivity (k) and concentration (φ) (and/or density (ρ)), are provided for measuring sedimentation of the solid-liquid two-phase mixture. To measure the sediment, thermal conductivities (k) are measured at settling times (t) to obtain a relationship (k−t). Concentrations (φ) and/or densities (ρ) are then determined, based on the measured relationship (k−t) and the standard work curve and/or the standard mathematical model. A sedimentation rate is determined according to a variation rate of the thermal conductivity. A sedimentation status, sedimentation degree, and/or complete sedimentation degree are determined according to variation rate and variation degree of the thermal conductivity (k), the concentration (φ) and/or the density (ρ) of the solid-liquid two-phase mixture to be measured.

### CROSS-REFERENCES TO RELATED APPLICATIONS

This application claims priority to Chinese Patent Application No. 201310207325.2, filed on May 29, 2013, the entire contents of which are incorporated herein by reference.

### FIELD OF THE DISCLOSURE

The present disclosure generally relates to the field of sedimentation of a solid-liquid two-phase mixture, and more particularly, relates to methods and apparatus for determining sedimentation rate, sedimentation status, sedimentation degree, and complete sedimentation degree of a solid-liquid two-phase mixture.

### BACKGROUND

A solid-liquid two-phase mixture includes solid particles dispersed in a liquid mixture. The solid-liquid two-phase mixture may be used in various smart fluids, enhanced heat transfer fluid, and chemical fluids. Due to density difference of the solid and liquid components in the fluid, the solid-liquid two-phase mixture is an unstable thermodynamic system, and the sedimentation of the solid particles often occurs in these fluids. In fact, a magnetorheological fluid (MRF) is limited in long term engineering application due to its sedimentation problem. Therefore, sedimentation rate and sedimentation status measurements are very important for fundamental material research and engineering application of the MRF, and for other similar solid-liquid two-phase mixtures, such as electrorheological fluids (ERF), nanofluids and magnetic fluids, and other chemical fluids.

Currently, a major method used to measure the sedimentation rate of a solid-liquid two-phase mixture includes an observational method. In this observational method, the amount of supernatant isolated from a solid-liquid two-phase mixture in a settling process is observed using naked eyes, and the sedimentation ratio can be calculated based on the ratio of the volume of supernatant over the total volume of the solid-liquid two-phase mixture. However, this method cannot be used to determine the sedimentation status and the complete sedimentation degree. Furthermore, the observation method is not applicable for opaque liquid or the solid-liquid two-phase mixture in which the color of both liquid and solid components are similar.

There are other sedimentation measurement methods including inductance method, sediment hardness method (U.S. Pat. No. 6,203,717), doctor blade method and damper testing method (U.S. Pat. No. 6,508,108). Among them, the inductance method is adopted in measuring the settling velocity of MRF based on the displacement rate of a solid-liquid boundary in MRF. However, the inductance method is not capable of determining the concentration of the solid-liquid two-phase mixture and the relationship between the concentrations and settling time.

In the sediment hardness method, sample sediment is taken from the mixture and its hardness is measured to determine whether the sediment can be dispersed again. However, this method is not capable of determining the sedimentation rate, and its accuracy is dependent on the experience of operators. In the doctor blade method, scraper is used to re-disperse sediments to determine sedimentation status, i.e., soft or hard sedimentation, according to the re-dispersibility. This method is heavily dependent on the experience of operators, and is difficult to quantitatively determine the sedimentation rate and sedimentation status.

In the damper testing method, the sedimentation status of the MRF in the damper is qualitatively analyzed by testing the damper behavior (U.S. Pat. No. 6,508,108). This method is also not suitable for measuring the sedimentation rate and sedimentation status of a solid-liquid two-phase mixture. In addition, a method and device to determine the sedimentation rate of particles in liquid samples are disclosed in U.S. Pat. No. 5,809,825, but it cannot be used for measuring the sedimentation status of solid-liquid two-phase mixture. Up to the date, there are no suitable methods and devices for measuring the sedimentation rate and status of a solid-liquid two-phase mixture.

Thus, there is a need to overcome these and other problems of the prior art and to provide methods and apparatus for measuring sedimentation rate, sedimentation status, sedimentation degree, and complete sedimentation degree of a solid-liquid two-phase mixture by measuring and analyzing a thermal conductivity variation rate and variation degree thereof. It is very important for the materials development, characterization and engineering application of solid-liquid two-phase mixture materials.

### BRIEF SUMMARY OF THE DISCLOSURE

One aspect or embodiment of the present disclosure provides a method for measuring sedimentation of a solid-liquid two-phase mixture. In the method, the solid-liquid two-phase mixture to be measured is provided. One or more of a standard work curve and a standard mathematical model are also provided. Each of the standard work curve and the standard mathematical model provides a relationship between a thermal conductivity (k) and a concentration (φ) or a relationship between a thermal conductivity (k) and a density (ρ). A thermal conductivity (k) of a sediment in the solid-liquid two-phase mixture to be measured is measured at each of a plurality of settling times (t) to obtain a relationship curve (k−t). The relationship curve (k−t) is converted into a relationship curve (φ−t) or a relationship curve (ρ−t) or both, based on the one or more of the standard work curve and the mathematical relationship. A concentration (φ) or a density (ρ) of the solid-liquid two-phase mixture to be measured is determined based on the measured thermal conductivity (k) at each of the plurality of settling times (t). A sedimentation rate of the solid-liquid two-phase mixture to be measured according to a variation rate of one or more of the thermal conductivity, the concentration, and the density. One or more of a sedimentation status, a sedimentation degree, and a complete sedimentation degree are determined according to one or more of a variation degree of the thermal conductivity (k), the concentration (φ) and the density (ρ) of the solid-liquid two-phase mixture to be measured.

Another aspect or embodiment of the present disclosure provides an apparatus for measuring sedimentation of a solid-liquid two-phase mixture. The apparatus includes a first unit, a second unit, and a third unit. The first unit includes a test probe configured to produce a precise amount of heat and measure a temperature transient at a plurality of different heights from a bottom of a sediment of the solid-liquid two-phase mixture to be measured, for the second unit to process to obtain a thermal conductivity. The second unit is configured to determine a measurement condition and procedure of the first unit, and process a signal from the first unit and determine a sedimentation rate, a sedimentation status, a sedimentation degree, and a complete sedimentation degree of the sedimentation of the solid-liquid two-phase mixture to be measured. The third unit is configured to display or transmit results sent from the second unit.

The first unit further includes a sample cell, a temperature control system, an adjustable heating power, and a power supply unit. The test probe is configured in the sample cell and the temperature control system is configured to control a temperature of the solid-liquid two-phase mixture contained in the sample cell. The second unit includes a signal amplifier connected to the test probe, a filter connected to the signal amplifier, and an analog to digital conversion (ADC) module connecting the filter and a micro control unit (MCU). An input module, a storage unit, and a power supply unit are all connected to the MCU. The third unit includes one or more of the storage unit, a communication unit, a display unit, a printing unit, and the power supply unit.

Other aspects or embodiments of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates an exemplary method for measuring sedimentation of a solid-liquid two-phase mixture in accordance with various disclosed embodiments;

FIG. 2 illustrates an exemplary relationship curve of a thermal conductivity vs. concentration of a solid-liquid two-phase mixture in accordance with various disclosed embodiments;

FIG. 3 illustrates an exemplary relationship curve of a thermal conductivity vs. density of a solid-liquid two-phase mixture in accordance with various disclosed embodiments;

FIG. 4 illustrates an exemplary thermal conductivity variation curve of a solid-liquid two-phase mixture in accordance with various disclosed embodiments;

FIG. 5 illustrates an exemplary concentration variation curve of a solid-liquid two-phase mixture in accordance with various disclosed embodiments;

FIG. 6 illustrates an exemplary density variation curve of a solid-liquid two-phase mixture in accordance with various disclosed embodiments;

FIG. 7 illustrates an exemplary apparatus for measuring sedimentation of a solid-liquid two-phase mixture in accordance with various disclosed embodiments;

FIG. 8 illustrates an exemplary test probe having a single sleeve structure in accordance with various disclosed embodiments;

FIG. 9 illustrates an exemplary test probe having a double sleeve structure in accordance with various disclosed embodiments;

FIG. 10 illustrates an apparatus for measuring sedimentation of a solid-liquid two-phase mixture connecting to a remote monitoring center in accordance with various disclosed embodiments;

FIG. 11 illustrates an exemplary relationship between a thermal conductivity and a volume fraction of carbonyl iron particles of a solid-liquid two-phase mixture including silicone oil and carbonyl iron particles in accordance with various disclosed embodiments;

FIG. 12 illustrates a thermal conductivity variation curve of a silicone oil MR fluid (carbonyl iron particles volume fraction 0.40) at different settling times in accordance with various disclosed embodiments;

FIG. 13 illustrates a concentration variation curve of a silicone oil MR fluid (carbonyl iron particles volume fraction 0.40) at different settling times in accordance with various disclosed embodiments;

FIG. 14 illustrates a thermal conductivity variation curve of a silicone oil MR fluid (silicone oil and carbonyl iron particles with a density of 3.73 g/cm³) at different settling times in accordance with various disclosed embodiments;

FIG. 15 illustrates a relationship between a thermal conductivity and a density of a solid-liquid two-phase mixture including silicone oil and carbonyl iron particles at different settling times in accordance with various disclosed embodiments;

FIG. 16 illustrates a density variation curve of a silicone oil MR fluid (silicone oil and carbonyl iron particles with a density of 3.73 g/cm³) at different settling times in accordance with various disclosed embodiments; and

FIG. 17 illustrates a variation curve of a thermal conductivity enhancement rate of an iron nanofluid (iron nanoparticles volume fraction 0.25%) at different settling times in accordance with various disclosed embodiments.

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts.

Methods and apparatus are provided for measuring sedimentation rate, sedimentation status, sedimentation degree, and complete sedimentation degree of a solid-liquid two-phase mixture by measuring and analyzing a thermal conductivity variation rate and variation degree thereof. The disclosed methods and apparatus are important for the material development, and/or characterization and engineering application of solid-liquid two-phase mixture materials.

For example, a simple and quantitative method and an inexpensive apparatus of measuring the sedimentation of solid-liquid two-phase mixtures by measuring and analyzing a thermal conductivity variation rate and variation degree.

In an exemplary method, a solid-liquid two-phase mixture is an unstable suspension having a dispersed phase in a continuous phase; the dispersed phase includes solid particles; and the continuous phase is liquid solvent; and a thermal conductivity may vary with a concentration or density thereof. In general, the thermal conductivity of solid particles is far higher than that of liquid, so that the thermal conductivity of the mixture at the bottom of the container can gradually increase as the sedimentation degree increases, because the concentration and/or density of the mixture at the bottom of the container may gradually increase as the sedimentation degree increases. Conversely, the thermal conductivity of the mixture at the upper portion of the container may gradually decrease as the sedimentation degree increases, because the concentration or density of the mixture at the upper of the container may gradually decrease as the sedimentation degree increases.

Therefore, the sedimentation rate can be obtained by measuring a thermal conductivity variation rate; and the sedimentation degree can be obtained by measuring a thermal conductivity variation degree. In other words, the variation rate of the thermal conductivity corresponds to the sedimentation rate; and the variation degree of the thermal conductivity corresponds to the sedimentation degree.

In various embodiments, a standard work curve or a standard mathematical model of quantitative analysis can be generated for converting thermal conductivity into concentration or density. By preparing standard samples and determining the thermal conductivities and concentrations (or densities) of standard samples, variation rate and variation degree of the thermal conductivity can be converted into variation rate and variation degree of the concentration or density, so that the measured sedimentation rate and sedimentation degree can be clear in physics.

Advantageously, the disclosed method and apparatus can be simple, inexpensive, accurate, and rapid, and can be applied to quantitatively determine the sedimentation rate, sedimentation status, sedimentation degree and complete sedimentation degree of solid-liquid two-phase mixtures, such as MRF, ERF, nanofluids, magnetic fluids, chemical fluids, and/or other solid-liquid two-phase mixtures.

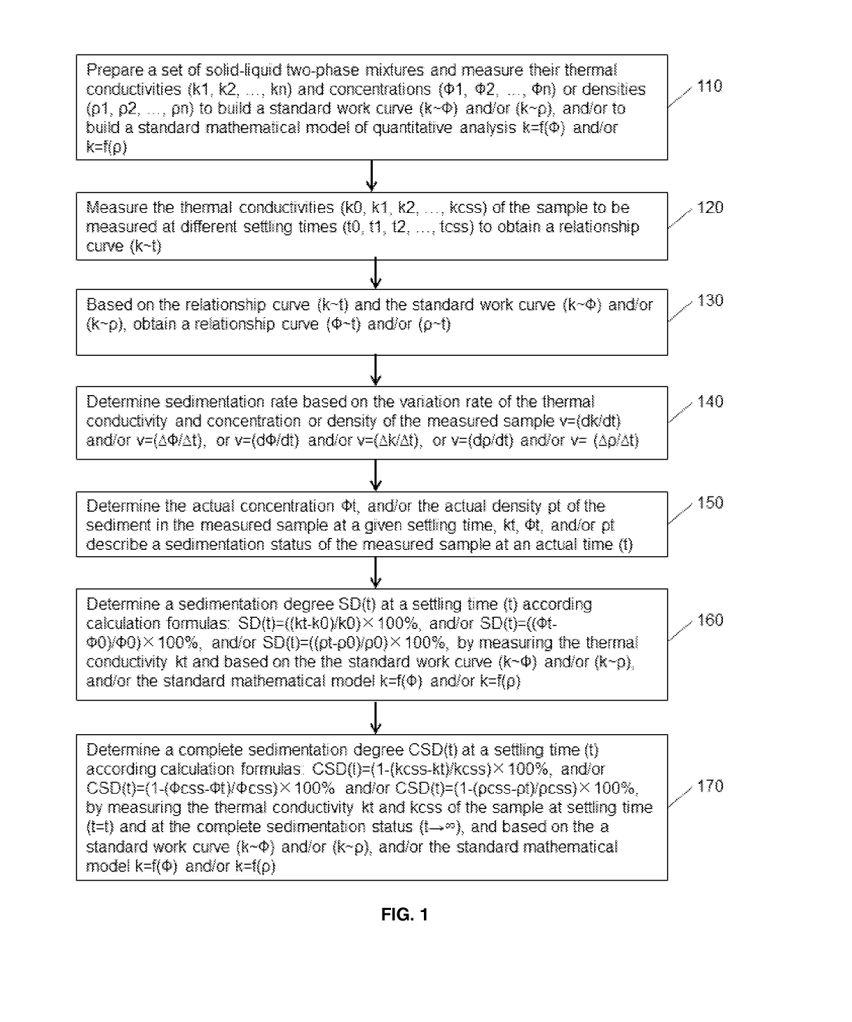

FIG. 1 shows an exemplary method for measuring sedimentation of a solid-liquid two-phase mixture in accordance with various disclosed embodiments. The measuring of sedimentation may include measuring of a sedimentation rate, a sedimentation status, a sedimentation degree, and a complete sedimentation degree, e.g., by measuring variation rate and variation degree of thermal conductivity with settling time, and converting the variation rate and variation degree of the thermal conductivity with settling time into variation rate and variation degree of the concentration with settling time or the variation rate and variation degree of the density with settling time.

In various embodiments, the sedimentation rate, sedimentation status, sedimentation degree, and complete sedimentation degree can be measured individually and/or together. The sedimentation rate, sedimentation status, sedimentation degree and complete sedimentation degree can be determined by variation rate and variation degree of the thermal conductivity and/or concentration and/or density), and/or other factors such as variation rate and variation degree of thermal conductivity enhancement.

In Step 110, standard work curve is built. In some embodiments, standard mathematical model of quantitative analysis can be built. For example, standard samples can be prepared and their thermal conductivities, concentrations, and densities can be calculated and measured. A relationship (k−φ) between thermal conductivity (k) and concentration (φ) of the measured solid-liquid two-phase mixture or a relationship between the thermal conductivity (k) and the density (ρ) of a measured solid-liquid two-phase mixture (k−ρ) can be built.

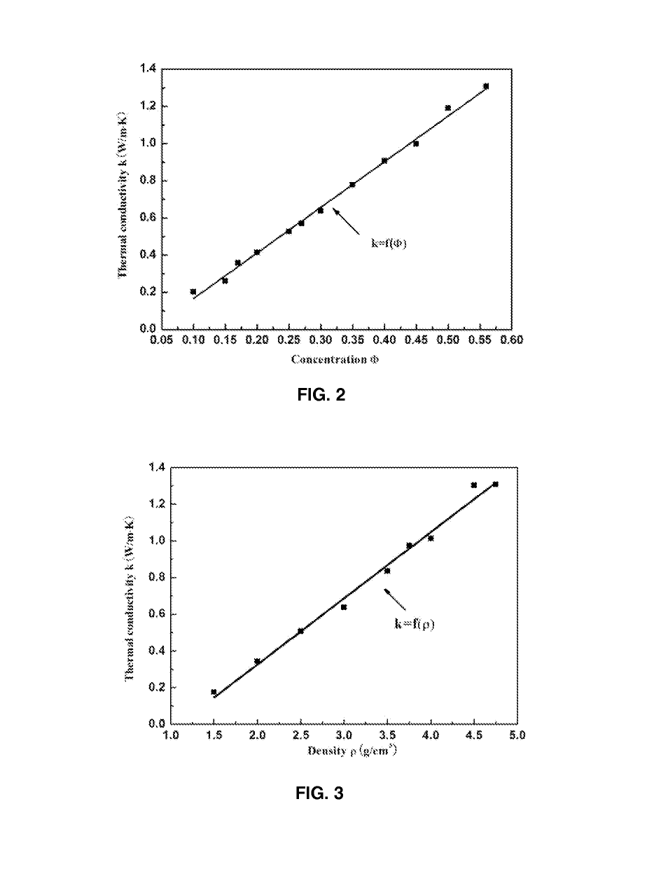

To build standard work curve (and/or to build standard mathematical model of quantitative analysis), a set of solid-liquid two-phase mixtures can be prepared having concentrations (φ1, φ2, . . . , φn) or densities (ρ1, ρ2, . . . , ρn), which can be obtained by theoretically calculation or experimental tests. Thermal conductivities (k1, k2, . . . , kn) of the solid-liquid two-phase mixtures can be respectively measured. In this manner, an exemplary standard work curve for a relationship (k−φ) between thermal conductivity (k) and concentration (φ) of the measured solid-liquid two-phase mixtures can be built, e.g., as shown in FIG. 2. In addition, an exemplary standard work curve for a relationship (k−ρ) between thermal conductivity (k) and density (ρ) of the measured solid-liquid two-phase mixtures can be built, e.g., as shown in FIG. 3. Accordingly, mathematic relationship k=f(φ) between thermal conductivity and concentration, and/or the mathematic relationship k=f(ρ) between thermal conductivity and density can be obtained, e.g., by data fitting.

In one embodiment, experiment results may show a mathematic relationship for the solid-liquid two-phase mixtures. The mathematic relationship can include a linear equation, although other forms of equations, e.g., quadratic equations, may also be included without any limitations. Therefore, one can turn the thermal conductivity (k) into concentration (φ) or density (ρ) with the mathematic relationship k=f(φ) or k=f(ρ), and vice versa.

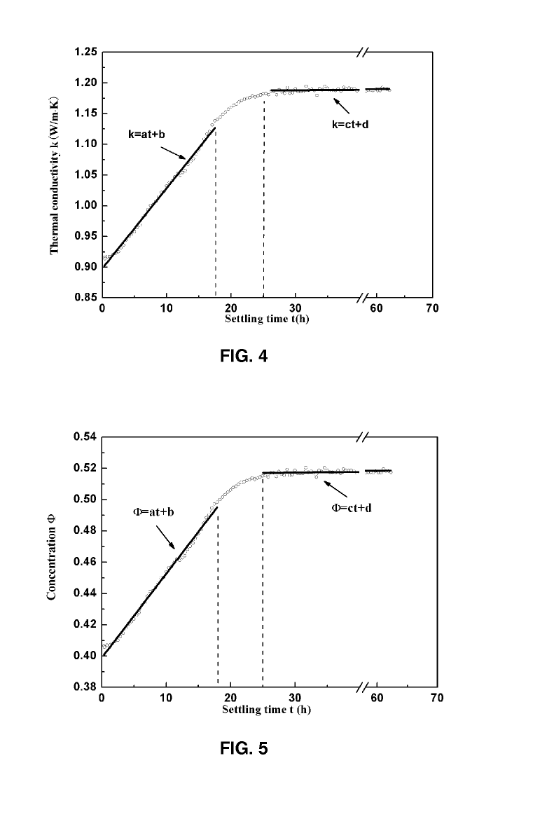

In Step 120, thermal conductivity of the solid-liquid two-phase mixtures can be measured with settling time (k−t). For example, thermal conductivities (k0, k1, k2, . . . , kcss) of the solid-liquid two-phase mixtures can be measured at different settling times (t0, t1, t2, . . . , tcss). Accordingly, FIG. 4 shows a relationship curve (k−t) based on data of thermal conductivity and settling time.

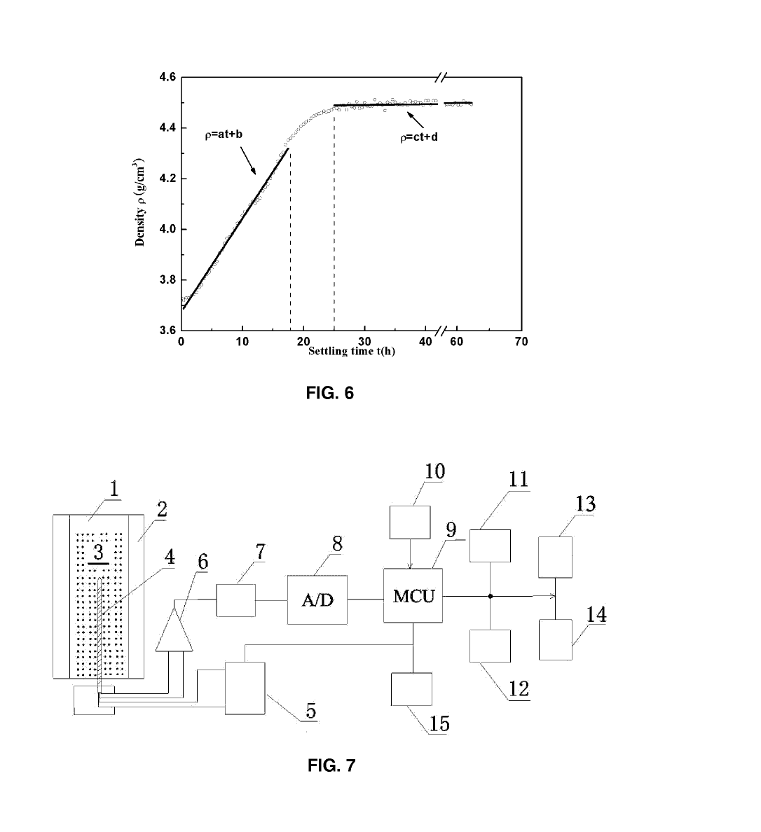

In Step 130, based on the relationship of thermal conductivity with settling time (k−t) and the relationship (k−φ) between thermal conductivity (k) and concentration (φ), a relationship of concentration with settling time (φ−t) can be obtained, for example, as shown in FIG. 5. Alternatively, a relationship between density and settling time (ρ−t) (e.g., as shown in FIG. 6) can be obtained according to the above standard work curve or standard mathematical model, e.g., according to the relationship of thermal conductivity with settling time (k−t) and the relationship (k−ρ) between thermal conductivity (k) and density (ρ).

In Step 140, a sedimentation rate can be determined based on the variation rate of the thermal conductivity and concentration or density of the measured solid-liquid two-phase mixtures. The sedimentation rate can be described by the variation rate of the thermal conductivity (k) or by the variation rate of the concentration (φ), as shown in FIG. 5, or by the variation rate of the density (ρ) with settling time, as shown in FIG. 6.

For example, instantaneous sedimentation rate can be determined by the first derivative (dk/dt) or (dφ/dt) or (dρ/dt). Similarly, an average sedimentation rate can be obtained by calculating their average variation rate of the thermal conductivity (Δk/Δt) or their average variation rate of concentration (Δφ/Δt) or their average variation rate of density (Δρ/Δt) within a given settling time region.

In Step 150, a sedimentation status can be determined by measuring the thermal conductivity kt, and/or the concentration φt, and/or the density ρt of the sediment in the measured solid-liquid two-phase mixture at a given settling time. The thermal conductivity can be directly measured; the concentration φt and density pt can also be directly measured, but preferably be indirectly obtained based on the measured thermal conductivity kt according to the standard work curve, and/or the standard mathematical model k=f(φ) and k=f(ρ) prepared in Step 110.

Because the value of kt is highly correlated to the actual concentration φt and/or density ρt, i.e., an actual sedimentation status, all of the obtained kt, φt, and pt can describe the sedimentation status of the measured sample at actual time (t). In one example, the sedimentation status can be described by the measured actual thermal conductivity kt. In a preferable example, the sedimentation status can be described by the obtained actual concentration of the sediment φt, because concentration is more intuitive than thermal conductivity.

In Step 160, a sedimentation degree can be determined at settling time (t).

In order to carry out quantitative calculation, SD(t) can be defined as the sedimentation degree of the measured solid-liquid two-phase mixture at settling time (t), following calculation formulas:

SD(t)=((kt−k0)/k0)×100% (1a)

SD(t)=((φt−φ0)/(φ0)×100% (1b)

SD(t)=((ρt−ρ0)/ρ0)×100% (1c)

where k0, φ0, and ρ0, and kt, φt, and pt denote thermal conductivity, concentration, and density of the solid-liquid two-phase mixture at settling time t=0 and t=t, respectively. SD(t) denotes the sedimentation degree of the measured solid-liquid two-phase mixture at settling time t=t. The value of SD(t) is proportional to the sedimentation degree. In other words, the sedimentation degree goes up with the increment of SD(t).

Therefore, the sedimentation degree SD(t) can be determined by firstly measuring the thermal conductivity (kt) of the sediment of the measured sample at settling time (t) and the thermal conductivity (k0) of the measured sample at no sedimentation status, and then figuring out the sedimentation degree SD(t) according to the formula SD(t)=((kt−k0)/k0)×100%. k0 and kt can then be converted to obtain φ0 and φt, and/or ρ0 and ρt. SD(t) can be determined according to the formula SD(t)=((φt−φ0)/φ0)×100%, and/or SD(t)=((ρt−ρ0)/ρ0)×100%.

In Step 170, a complete sedimentation degree can be determined at settling time (t).

In order to carry out quantitative calculation, CSD(t) is defined as the complete sedimentation degree of the solid-liquid two-phase mixture measured at settling time (t), following calculation formulas:

CSD(t)=(1−(kcss−kt)/kcss)×100% (2a)

CSD(t)=(1−(φcss−φt)/(φcss)×100% (2b)

CSD(t)=(1−(ρcss−ρt)/ρcss)×100% (2c)

where kt, φt, pt and kcss, φcss, ρcss are thermal conductivity, concentration and density of the solid-liquid two-phase mixture measured at settling time (t=t) and at the complete sedimentation status (t→∞), respectively. CSD(t) denotes the complete sedimentation degree of the solid-liquid two-phase mixture measured at settling time t=t. In other words, if the value of CSD(t) is equal to 100%, the measured solid-liquid two-phase mixture is close to a complete sedimentation status, i.e., to be deposited completely from chemical fluids, and to form hard settle for MR fluids.

Therefore, the complete sedimentation degree CSD(t) can be determined by firstly measuring the thermal conductivity kt of the sediment of the measured sample at settling time (t) and the thermal conductivity of the measured sample at complete sedimentation status kcss, and then determining the complete sedimentation degree CSD(t) according to the formula CSD(t)=(1−(kcss−kt)/kcss)×100%. From the value of kt and kcss, φt and φcss, and/or ρt and ρcss can be obtained. The complete sedimentation degree CSD(t) can then be obtained according to the formula CSD(t)=(1−(φcss−φt)/φcss)×100% and/or CSD(t)=(1−(ρcss−ρt)/ρcss)×100%.

To obtain the value of kcss, φcss, and ρcss, a sediment sample can be prepared at a complete sedimentation status using a high velocity centrifugation or by natural long-term sedimentation. The thermal conductivity kcss of the sediment can be measured. From the value of kcss, φcss and/or ρcss can be obtained according to the mathematic relationship k=f(φ) between thermal conductivity and concentration, and/or the mathematic relationship k=f(ρ) between thermal conductivity and density. Or the thermal conductivity kcss, concentration φcss and density ρcss of the sediment can be directly measured.

The above method can be carried out with a suitable instrument which can measure the thermal conductivity of a solid-liquid two-phase mixture. In one embodiment, an exemplary instrument can include apparatus disclosed in the present disclosure.

For example, an apparatus can be provided to measure sedimentation rate, sedimentation status, sedimentation degree, and complete sedimentation degree of a solid-liquid two-phase mixture based on the above method. As shown in FIGS. 7-10, the disclosed apparatus can include: a sample cell (1); a temperature control system (2); a test probe (4); an adjustable heating power (5); a signal amplifier (6); a filter (7); an ADC (analog to digital conversion module)(8); a MCU (micro control unit) (9); an input module (10); a storage unit (11); a communication unit (12); a display unit (13); a printing unit (14); and a power supply unit (15).

The solid-liquid two-phase mixture (3) is contained in sample cell (1) of device. The sample cell (1) can be an exclusively designed container, but also can be a barrel of devices containing solid-liquid two-phase mixture, such as magnetorheological fluid dampers. The container shape can be arbitrary and can be cylindrical, rectangular, square, single-deck, bilayer with jacket, or multilayer with jacket. The material of the container can be arbitrary and can include glass, metal, alloy, ceramic, wood, polymer composite, and/or concrete.

The temperature control system (2) is used for controlling the temperature of the sample. The temperature control system (2) can include, but be not limited to, water bath temperature control system, oil bath temperature control system, sand bath temperature control system, ice water bath temperature control system, steam bath temperature control system, electric jacket temperature control system, resistance wire temperature control system, heat and cold air temperature control system, and/or air-conditioning system.

The test probe (4) is inserted into the sample. The test probe (4) contains a line-source heater and multiple temperature sensors, an insulating material having a high thermal conductivity (19) and a metal sleeve (16). The line-source heater is configured to produce a precise amount of heat, and the multiple temperature sensors are configured to measure temperature transients of the solid-liquid two-phase mixture to be measured. The multiple temperature sensors (18) are equally spaced at different positions (e.g., at least three positions) along a length of the metal sleeve, which is especially designed for the present disclosed apparatus, and can be used to obtain an average thermal conductivity of the sample being tested at different position, which is very important for to reduce the error due to the different thermal conductivity of the sample at different position because the concentration at different position will be different as the sedimentation take place.

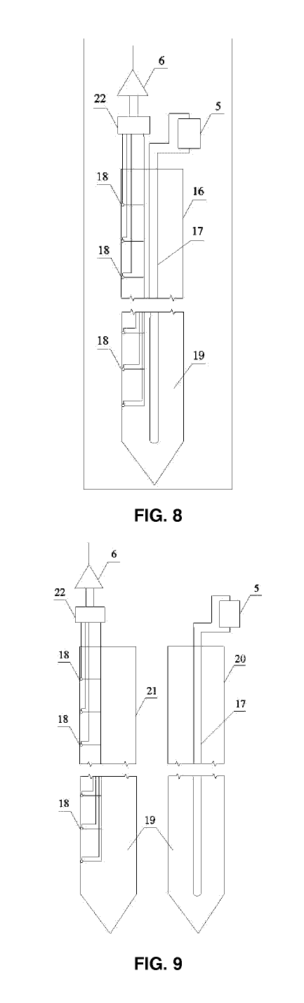

In some embodiments, the test probe (4) can be made having a single sleeve structure, as shown in FIG. 8, including a metal sleeve (16), a line-source heater (17), a multiple temperature sensors (18), an insulating materials (19) and a multiplexer (22). The line-source heater produces a precise amount of heat, the multiple temperature sensors measure the temperature transients at different position, wherein the line-source heater (17) is enclosed and fixed in the metal sleeve by filling with an insulating material having a high thermal conductivity (19), and the multiple temperature sensors (18) are enclosed in the metal sleeve and equally spaced at different positions along a length of the metal sleeve, as shown in FIG. 8.

In other embodiments, the test probe (4) can be made having a double sleeve structure, as shown in FIG. 9, including a line-source heater (17), a multiple temperature sensors (18), an insulating materials (19), a multiplexer (22), a first metal sleeve (20), and a second metal sleeve (21). The line-source heater (17) and insulating materials (19) are encapsulated in the first metal sleeve (20). The multiple temperature sensors (18) and insulating materials (19) are encapsulated in the second metal sleeve (21). The multiple temperature sensors (18) are equally spaced at different positions along a length of the sleeve, as shown in FIG. 9.

The adjustable heating power (5) is connected to the line-source heater (17) in the test probe. The signal amplifier (6) is connected to the multiple temperature sensors (18) via multiplexer (22). The filter (7), ADC (8), and micro control unit (9) are sequentially connected with one another as shown in FIG. 7. The signal of the temperature transients are transmitted into the micro control unit (9) via the signal amplifier (6), the filter (7), and the ADC (8); the micro control unit (9) processes the data and figures out the average conductivity k(t) at a given settling time, and then plots out a relationship curve (k−t) within a given settling time range (t1-tn), and also convert the relationship curve (k−t) into relationship curve (φ−t) and/or (ρ−t), and finally determines sedimentation rate, sedimentation status, sedimentation degree and complete sedimentation degree. The input module (10), storage unit (11), communication unit (12), display unit (13), and printing unit (14) are connected with the micro control unit (9). The power supply unit (15) is connected to the adjustable heating power (5) and the micro control unit (9).

The storage unit (11) can be a USB flash disk or optical disk or hard disk or floppy disk or storage card or memory stick or combinations thereof. The communication unit (12) is used to transmit measurement data using a wired transmission or a wireless transmission using, e.g., optical fiber, optical cable, data line, coaxial line, twisted pair, guide line, wireless, satellite, and/or cellular network.

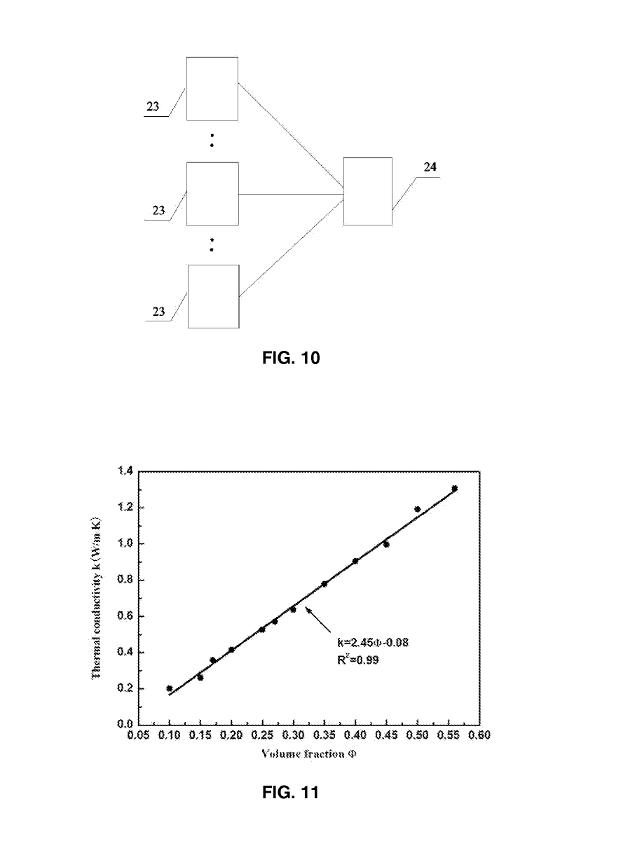

The testing results, including sedimentation rate, sedimentation status, sedimentation degree (SD), and the complete sedimentation degree, can be directly displayed and printed out, and can be transmitted to a remote monitoring center via communication unit, as shown in FIG. 10.

The sedimentation rate, sedimentation status, sedimentation degree and complete sedimentation degree can be directly measured and determined by the device shown in FIGS. 7-10.

In a first step, a set of data for thermal conductivities (k1, k2, . . . , kn) and concentrations (φ1, φ2, . . . , φn) or densities (ρ1, ρ2, . . . , pn) of the measured solid-liquid two-phase mixture (e.g., known from previous experiment measurements) can be inputted for the micro control unit to determine a relationship between the thermal conductivity and the concentration (k−φ), as shown in FIG. 2, and/or a relationship between the thermal conductivity and the density (k−ρ), as shown in FIG. 3. The micro control unit can also determine a mathematic relationship k=f(φ) between thermal conductivity and concentration, and/or a mathematic relationship k=f(ρ) between thermal conductivity and density by a data fitting process.

In a second step, determining a measurement condition and procedure, including testing temperature (e.g., 25° C.), heat output per unit length of the line-source heater, measurement time per recording (e.g., 15 s), continuous testing or intermittent testing, auto or manual mode, time interval between twice test (e.g., 25 minutes), frequency of data acquisition (e.g., two times very second), a given measured settling time range (t0, t1, t2, ti, . . . , tn), which can be inputted by the input module; switching on the power supply and starting on testing, the device directly measure the thermal conductivity of the measured solid-liquid two-phase mixture at a given settling time (t0, t1, t2, ti, . . . , tn). The micro control unit can determine the thermal conductivities (k0, k1, k2, ki, . . . , kn) of the measured solid-liquid two-phase mixture at corresponding settling times (t0, t1, t2, ti, . . . , tn), based on the principle of the line heat source method, and plot out a variation diagram of the thermal conductivity vs. settling time (k−t), as shown in FIG. 4. Meanwhile themicro control unit can convert the curve of thermal conductivity vs. settling time (k−t) into a curve of concentration vs. settling time (φ−t), as shown in FIG. 5, or into a curve of the density vs. settling time (p−t) according to the above relationship between the thermal conductivity and concentration (or density) of the measured solid-liquid two-phase mixture, as shown in FIG. 6.

In a third step, a settling time region (t1-tn) can be inputted and the micro control unit can determine corresponding thermal conductivities (k1-kn), and plot out a relationship curve (k−t) within a given settling time range (t1-tn), and also convert the relationship curve (k−t) into relationship curve (φ−t) and/or (ρ−t), and then determine an instantaneous sedimentation rate by a first derivative (dk/dt) or (dφ/dt) or (dρ/dt). The micro control unit can further calculates the average sedimentation rate by calculating their average variation rate of the thermal conductivity (Δk/Δt), or of the concentration (Δφ/Δt), or of the density (Δρ/Δt) within a given settling time range (t1-tn).

In a fourth step, k0 and kcss, or φ0 and φcss, or ρ0 and ρcss and settling time (t) can be inputted by the input module. The micro control unit determines kt or φt or ρt, and calculates to obtain SD(t) and CSD(t) according to the following formulas: SD(t)=((kt−k0)/k0)×100%, or SD(t)=((φt−φ0)/φ0)×100%, or SD(t)=((ρt−ρ0)/ρ0)×100%, and CSD(t)=(1−(kcss−kt)/kcss)×100%, or CSD(t)=(1−(φcss−φt)/φcss)×100%, or CSD(t)=(1−(ρcss−ρt)/ρcss)×100%.

In a fifth step, the testing results can be directly displayed and printed out, and can be transmitted to the remote monitoring center by wireless or wired connections, as shown in FIG. 10.

Various embodiments thus provide an apparatus for measuring sedimentation of a solid-liquid two-phase mixture. The apparatus includes a first unit, a second unit, and a third unit. The first unit is configured to produce a precise amount of heat and measure the temperature transients; the second unit is configured to process data sent from the first unit, and the third unit is configured to display or transmit results sent from the second unit.

The first unit is configured to produce a precise amount of heat and measure the temperature transients at a plurality of different heights of a bottom of the sedimentation of the solid-liquid two-phase mixture to be measured, for the second unit to figure out an average temperature transient and average thermal conductivity (k) of a sediment in the solid-liquid two-phase mixture to be measured at each of a plurality of settling times. The first unit includes a test probe, a sample cell, a temperature control system, an adjustable heating power, and a power supply unit. The test probe is configured in the sample cell and the temperature control system is configured to control a temperature of the solid-liquid two-phase mixture contained in the sample cell. The adjustable heating power is connected to a line-source heater of the test probe, and the signal amplifier is connected to the multiple temperature sensors of the test probe via multiplexer. The input module, the storage unit, the communication unit, the display unit, and the printing unit are connected with the micro control unit. The power supply unit is connected to adjustable heating power and micro control unit.

The first unit includes a test probe including a single sleeve structure. The single sleeve structure includes a metal sleeve, a line-source heater, and multiple temperature sensors, an insulating materials and a multiplexer, wherein the line-source heater produces the precise amount of heat, the multiple temperature sensors measure the temperature transient, wherein the line-source heater is enclosed and fixed in the metal sleeve by filling with an insulating material having a high thermal conductivity, and the multiple temperature sensors are enclosed in the metal sleeve and equally spaced at three positions or more along a length of the metal sleeve.

Alternatively, the first unit includes a test probe including a double sleeve structure. The double sleeve structure includes a first metal sleeve, a second metal sleeve, an line-source heater, multiple temperature sensors, an insulating materials, and a multiplexer, wherein the line-source heater and the insulating material are encapsulated in the first metal sleeve, and the multiple temperature sensors and the insulating material are encapsulated in the second metal sleeve, the multiple temperature sensors are equally spaced at three positions or more along a length of the second metal sleeve, and the first and the second metal sleeves are filled with an insulating material having a high thermal conductivity.

The second unit is configured to determining a measurement condition and procedure of the first unit, including testing temperature, heat output per unit length of the line-source heater, measurement time per recording, continuous testing or intermittent testing, auto or manual mode, frequency of data acquisition, a given measured settling time range (t0, t1, t2, ti, . . . , tn), and to collect and process of a signal including the temperature transient sent from the first unit and the settling time, to calculate to obtain the thermal conductivity at each of a plurality of settling times and to obtain an average thermal conductivity at each settling time, and to determine a concentration (φ) or a density (ρ) of the solid-liquid two-phase mixture to be measured, based on the measured thermal conductivity (k) and one or more of a standard work curve and a mathematical relationship; to determine a sedimentation rate of the solid-liquid two-phase mixture to be measured according to a variation rate of the thermal conductivity; and to determine one or more of a sedimentation status, a sedimentation degree, and a complete sedimentation degree according to one or more of the thermal conductivity, the concentration (φ) and the density (ρ) of the solid-liquid two-phase mixture to be measured.

The second unit includes a signal amplifier connected to the test probe, a filter connected to the signal amplifier, and an analog to digital conversion (ADC) module connecting the filter with a micro control unit (MCU). An input module, a storage unit, and a power supply unit are all connected to the MCU.

The third unit includes one or more of the storage unit, a communication unit, a display unit, a printing unit, and the power supply unit.

### Example 1

The sedimentation rate, sedimentation status, sedimentation degree and complete sedimentation degree of a solid-liquid two-phase mixture (e.g., a MR fluid labeled as MRF9 (φ=0.4) was measured in this example.

The first step was to prepare a group of MR fluids with silicone oil (dimethyl silicone oil 201, Changzhou Longcheng organic silicon Co. Ltd.) and carbonyl iron powder (Jiangsu Tianyi superfine metal powder Co., Ltd). The MR fluids were labeled as MRF1, MRF2, MRF3, MRF4, MRF5, MRF6, MRF7, MRF8, MRF9, MRF10, MRF11, MRF12, respectively; and their concentrations (volume fraction of carbonyl iron powder) included: φ(MRF1)=0.10, φ(MRF2)=0.15, φ(MRF3)=0.17, φ(MRF4)=0.20, φ(MRF5)=0.25, φ(MRF6)=0.27, φ(MRF7)=0.30, φ(MRF8)=0.35, φ(MRF9)=0.40, φ(MRF10)=0.45, φ(MRF11)=0.50, and φ(MRF12)=0.56, respectively.

The second step was to test their thermal conductivities at 25° C. The tested results were k(MRF1)=0.201 W/(m·K), k(MRF2)=0.261 W/(m·K), k(MRF3)=0.358 W/(m·K), k(MRF4)=0.415 W/(m·K), k(MRF5)=0.527 W/(m·K), k(MRF6)=0.570 W/(m·K), k(MRF7)=0.638 W/(m·K), k(MRF8)=0.778 W/(m·K), k(MRF9)=0.906 W/(m·K), k(MRF10)=0.997 W/(m·K), k(MRF11)=1.192 W/(m·K), and k(MRF12)=1.307 W/(m·K), respectively.

The third step was to plot out a relationship (k−φ) curve between thermal conductivity (k) and volume fraction (φ), as shown in FIG. 11. A mathematical relationship k=f(φ)=2.45φ−0.08 (0.10≦φ≦0.56) was obtained by a data fitting process, with a correlation coefficient square of data fitting of about 0.99.

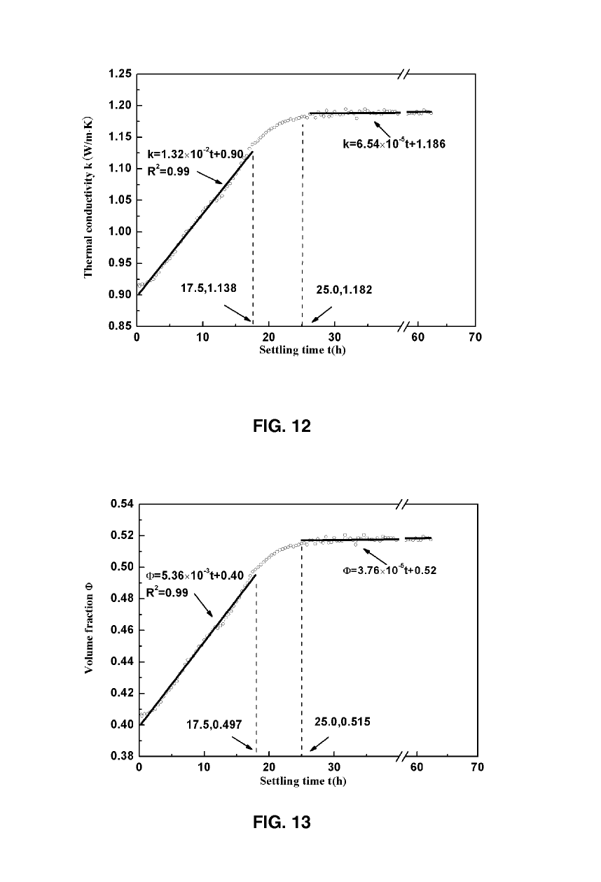

The fourth step was to measure the thermal conductivities of MRF9 at different settling times, and plotted out a relationship (k−t) curve between the thermal conductivity and settling time, as shown in FIG. 12. Based on the relationship (k−t) curve between thermal conductivity and settling time, a relationship (φ−t) curve between concentration and settling time (φ−t) was obtained, as shown in FIG. 13.

The fifth step was to calculate the sedimentation rate. The above FIG. 12 and FIG. 13 show that the thermal conductivity (k) and concentration (φ) of sediment of MRF9 increased as settling time increases. By the data fitting process, it is determined in FIGS. 12-13 that k=1.32×10⁻²t+0.90 (0≦t≦17.5 h), the slope is 1.32×10⁻² W/(m·K·h); and φ=5.36×10⁻³t+0.40 (0≦t≦17.5 h), the slope is 5.36×10⁻³ h⁻¹. This means that the concentration of the sediment increases at a velocity of 5.36×10⁻³ h⁻¹ in a range of 0-17.5 h, i.e., the sedimentation rate is 5.36×10⁻³ h⁻¹ (0≦t≦17.5 h).

When it is determined in FIG. 12 and FIG. 13, k=6.54×10⁻⁵t+1.186 (25 h≦t≦60.5 h), the slope is 6.54×10⁻⁵ W/(m·K·h), and φ=3.76×10⁻⁵t+0.52 (25≦t≦60.5 h), the slope is equal to 3.76×10⁻⁵ h⁻¹. This means that the sedimentation rate is 3.76×10⁻⁵ h⁻¹ in the range of 25 h-60.5 h and is slower than that in the range of 0-17.5 h.

The sixth step was to analyze sedimentation status, sedimentation degree and complete sedimentation degree of MRF9 at settling times of 15 h and 60 h, respectively. At first, a sediment sample of MRF9 at a complete sedimentation status was prepared by centrifuging the MRF9 30 minutes at 10000 rpm. The thermal conductivity kcss of the sediment was then measured kcss=1.307 W/(m·K). The thermal conductivity of the sediment of MRF9 at settling time 15 h and 60 h was measured, respectively, k15 h=1.143 W/(m·K) and k60 h=1.214 W/(m·K). Finally, it was then figured out that φ15 h=0.48, φ60 h=0.52 and φcss=0.56 according to the above mathematical relationship k=f(φ)=2.45φ−0.08. Therefore, the concentration of the sediment 0.48 and 0.52 was the sedimentation status at settling time 15 h, 60 h, respectively. In other words, the concentration of the sediment had increased to 0.48 and 0.52 from 0.40 when the settling time was changed from 0 h to 15 h and to 60 h, respectively.

Furthermore, the sedimentation degree SD(t) and the complete sedimentation degree CSD(t) of the measured sample at settling times 15 h and 60 h were determined, according to the following formula: SD(t)=((kt−k0)/k0)×100% or SD(t)=((φt−φ0)/φ0)×100%, and CSD(t)=(1−(kcss−kt)/kcss)×100% or CSD(t)=(1−(ccss−φt)/φcss)×100%. When putting k0 h(=0.906), k15 h(=1.143) k60 h (=1.214), φ15 h(=0.48) and φ60 h(=0.52), φCSS(=0.56) into the above formulas, it can be obtained that SD(15 h)=20%, SD(60 h)=30% and CSD(15 h)=85.7%, CSD(60 h)=92.9%. The results showed that the sedimentation degree of MRF9 at settling time 15 h were smaller than that at settling time 60 h, the sediment at settling time 60 h was close to the complete sedimentation status.

### Example 2

The sedimentation rate, sedimentation status, sedimentation degree and complete sedimentation degree of a solid-liquid two-phase mixture (e.g., a MR fluid labeled as MRF18 (ρ=3.73 g/cm³)) was measured in this example.

The first step is to prepare a group of MR fluids with silicone oil (dimethyl silicone oil 201, Changzhou Longcheng organic silicon Co. Ltd.) and carbonyl iron powder (Jiangsu Tianyi superfine metal powder Co., Ltd). The MR fluids were labeled as MRF13, MRF14, MRF15, MRF16, MRF17, MRF18, MRF19, MRF20, MRF21, respectively; and their densities were measured: ρ(MRF13)=1.50 g/cm³, ρ(MRF14)=2.00 g/cm³, ρ(MRF15)=2.50 g/cm³, ρ(MRF16)=3.00 g/cm³, ρ(MRF17)=3.50 g/cm³, ρ(MRF18)=3.73 g/cm³, ρ(MRF19)=4.00 g/cm³, ρ(MRF20)=4.50 g/cm³, and ρ(MRF21)=4.75 g/cm³, respectively.

The second step was to test their thermal conductivities at 25° C. The tested results were k(MRF13)=0.176 W/(m·K), k(MRF14)=0.343 W/(m·K), k(MRF15)=0.507 W/(m·K), k(MRF16)=0.638 W/(m·K), k(MRF17)=0.836 W/(m·K), k(MRF18)=0.906 W/(m·K), k(MRF19)=1.013 W/(m·K), k(MRF20)=1.303 W/(m·K), and k(MRF21)=1.307 W/(m·K), respectively.

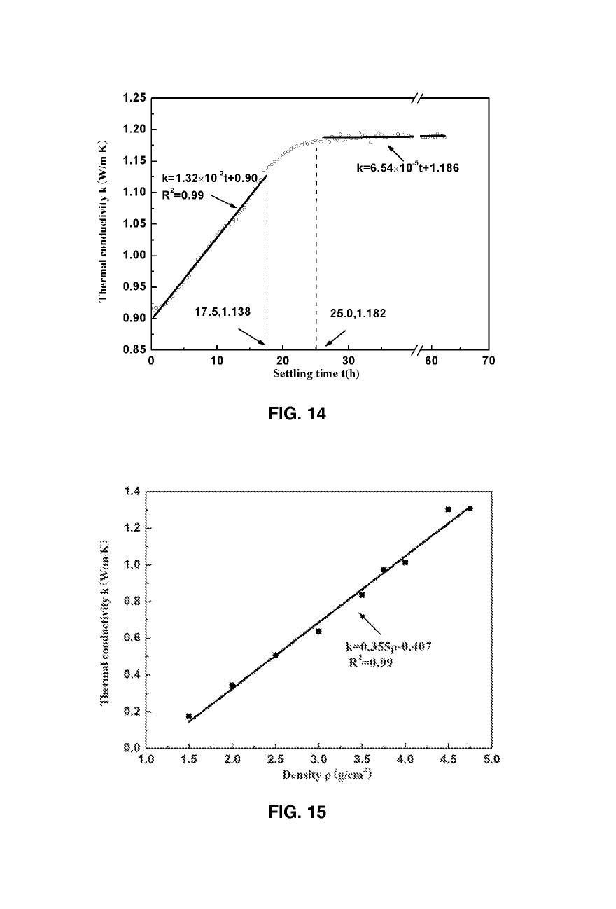

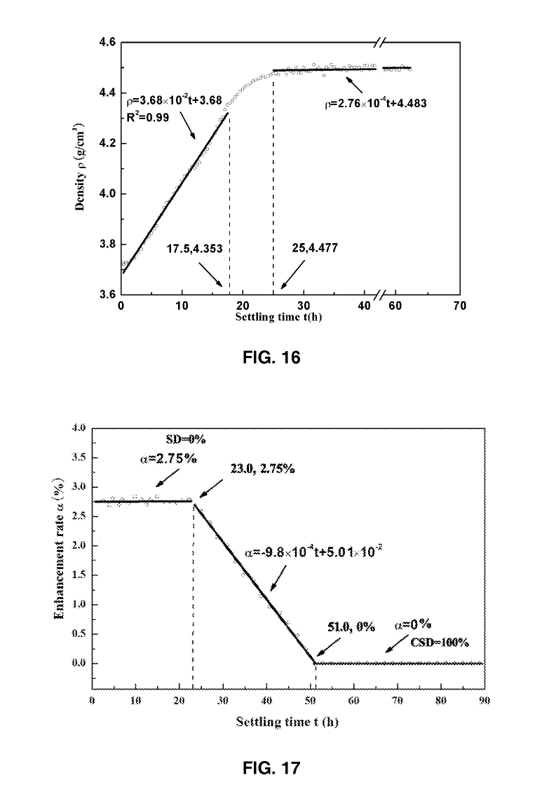

The third step was to select a MRF18 (ρ=3.73 g/cm³) as a sample to be measured, and put the sample into the sample cell (1) shown in FIG. 7, then controlled the temperature of the sample up to about 25° C. with the temperature control system (2), and inserted the test probe (4) into the sample (3) and turned on the power supply unit (15). Meanwhile, determining testing temperature (25° C.), heating power (3.0 W/m), measurement time per recording (25 s), manual mode, frequency of data acquisition (two times very second), measured settling time range (t0, t1, t2, ti, . . . , tn), see FIG. 14. The testing switch was then turned on for starting test. The line-source heater (17) in the test probe was connected to the adjustable heating power (5) to continuously heat the sample (3). The temperature sensors (18) collected the signals about the temperatures of the sample at different positions (e.g., heights), and the signals were sequentially transferred into the micro control unit (9) via a multiplexer (22), signal amplifier (6), the filter (7), and ADC (8). Thus the micro control unit first figured out the thermal conductivities at the same time and took the average value as the thermal conductivity at a settling time, then determined the thermal conductivities (k0, k1, k2, ki, . . . , kn) of the sediment of MRF18 at corresponding settling times (t0, t1, t2, ti, . . . , tn), and plotted out the curve (k−t) of the thermal conductivity vs. settling time, as shown in FIG. 14.

The fourth step was to plot out a relationship (k−ρ) curve of thermal conductivity (k) vs. density (ρ). The densities obtained in the first step and the thermal conductivities obtained in the second step were inputted by the input model: ρ(MRF13)=1.50 g/cm³, ρ(MRF14)=2.00 g/cm³, ρ(MRF15)=2.50 g/cm³, ρ(MRF16)=3.00 g/cm³, ρ(MRF17)=3.50 g/cm³, ρ(MRF18)=3.73 g/cm³, ρ(MRF19)=4.00 g/cm³, ρ(MRF20)=4.50 g/cm³, ρ(MRF21)=4.75 g/cm³, and k(MRF13)=0.176 W/(m·K), k(MRF14)=0.343 W/(m·K), k(MRF15)=0.507 W/(m·K), k(MRF16)=0.638 W/(m·K), k(MRF17)=0.836 W/(m·K), k(MRF18)=0.906 W/(m·K), k(MRF19)=1.013 W/(m·K), k(MRF20)=1.303 W/(m·K), k(MRF21)=1.307 W/(m·K). The micro control unit plotted out the relationship (k−ρ) curves between the thermal conductivity and the density, as shown in FIG. 15. The micro control unit also determined the mathematic relationship k=f(ρ) between thermal conductivity and density by a data fitting process: k=f(ρ)=0.355ρ−0.407 (1.50≦ρ≦4.75), and the correlation coefficient square of data fitting is about 0.99, as shown in FIG. 15.

The fifth step was that the micro control unit automatically converts the relationship (k−t) of the thermal conductivity vs. settling time into a relationship (ρ−t) of the density vs. settling time according to the above relationship (k−ρ) between the thermal conductivity and density, as shown in FIG. 15.

The sixth step was to analyze the sedimentation rate and input a settling time region (t1=0−tn=17.5 h). The micro control unit determined the sedimentation rate by a linear data fitting process. The result of linear fitting was ρ=3.68×10⁻²t+3.68 (0≦t≦17.5 h), the slope is 3.68×10⁻² h⁻¹, namely the average sedimentation rate=3.68×10⁻² g·cm⁻³·h⁻¹ (0≦t≦17.5 h).

The seventh step was to deduce the sedimentation status, sedimentation degree, and complete sedimentation degree of MRF18 at settling times 12 h and 50 h, respectively. At first, a sediment sample of MRF18 at the complete sedimentation status was prepared by centrifuging the MRF18 30 minutes at 10000 rpm. The thermal conductivity kcss of the sediment was then measured: kcss=1.307 W/(m·K). By inputting the settling times 12 h and 50 h, kcss=1.307 W/(m·K), and k0=0.906 W/(m·K) from the input model, the micro control unit determined the thermal conductivities of the sediment of MRF18 at settling times 12 h and 50 h by a data process: k12 h=1.058 W/(m·K) and k50 h=1.189 W/(m·K). The densities of the sediment of MRF18 at settling times 12 h and 50 h were obtained according to the formula k=f(ρ)=0.355ρ−0.407: ρ12 h=4.13 g/cm³, ρ50 h=4.49 g/cm³, ρ0=3.73 g/cm³ and ρcss=4.83 g/cm³. Therefore, the density of the sediment 4.13 g/cm³ and 4.49 g/cm³ is the sedimentation status at settling times 12 h and 50 h, respectively. In other words, the density of the sediment of MRF18 had increased to 4.13 g/cm³ and 4.49 g/cm³ from 3.73 g/cm³ when the settling time was changed from 0 h to 12 h and to 50 h.

Furthermore, the micro control unit determined the sedimentation degree (SD), and the complete sedimentation degree at settling times 12 h and 50 h, according following formula: SD(t)=((ρt−ρ0)/ρ0)×100% and CSD(t)=(1−(ρcss−ρt)/ρcss)×100%, SD(12 h)=10.7, SD(50 h)=20.4% and CSD(12 h)=85.5%, CSD(50 h)=93.0%. The results showed that the sedimentation degree of MRF18 at settling times 12 h were small than that at settling time 50 h, the sediment at settling time 50 h was close to the complete sedimentation status.

The eighth step was to display and print the test results. The testing results of sedimentation rate, sedimentation status, sedimentation degree (SD), and the complete sedimentation degree can be directly displayed and printed out, and can be transmitted to remote monitoring center via communication unit, as shown in FIG. 10.

### Example 3

Sedimentation status of MR fluid (MRF9) in a MR damper at settling times 60 days and 360 days was measured in this example.

The measured sample was MRF9 as in Example 1, which was filled into a MR damper. This MR damper was used as a sample cell and was placed horizontally. The test probe was inserted into the measured sample MRF9 from the side of the damper. The environment temperature was about 25° C. According to the method described in Example 2, the apparatus measured the thermal conductivities of the sample at different settling times (0 day, 60 days, and 360 days). The data of thermal conductivity varying with settling time were processed by the micro control unit, and were stored in the storage unit. By inputting settling times 0 day, 60 days, and 360 days, the micro control unit determined the thermal conductivities of sample MRF9 at settling time, 0 day, 60 days, and 360 days, respectively: k0 d=0.906 W/(m·K), k60 d=1.214 W/(m·K), and k360 d=1.277 W/(m·K). According to the mathematic relationship k=f(φ)=2.450−0.08 (0.10≦φ≦0.56) obtained from Example 1, the thermal conductivities of sample MRF9 at settling times 0 day, 60 days, and 360 days were converted to the concentrations: φ0 d=0.400 (0 d), φ60 d=0.528 (60 d), φ360 d=0.554 (360 d). The results indicated that the sedimentation status at settling times 60 d and 360 d had a concentration increased to 0.528 (60 d) and 0.554 (360 d) from 0.400 (0 d). Furthermore, according to the formula SD(t)=((φt−φ0)/φ0)×100%, CSD(t)=(1−(φcss−φt)/(φcss)×100%, and φcss=0.560, the sedimentation degree SD(t) and complete sedimentation degree CSD(t) of MRF9 in damper at settling times 60 days and 360 days were obtained by calculations: SD(60 d)=32.0%, SD(360 d)=38.5% and CSD(60 d)=95.4%, CSD(360 d)=98.9%.

### Example 4

Sedimentation of an iron nanofluid (0=0.25%) was measured in this example.

The sample iron nanofluid to be measured was prepared having silicone oil (volume fraction 99.75%) and iron nanoparticles (volume fraction 0.25%). Because the thermal conductivity of the base liquid silicone oil can be enhanced by adding iron nanoparticles, the thermal conductivity of iron nanofluid is proportional to the volume fraction of iron nanoparticles. In other words, the thermal conductivity enhancement rate of iron nanofluid at the upper of the container decreases as the sedimentation degree increases. Therefore, the thermal conductivity of silicon oil at 25° C. (labeled as kl) and the thermal conductivities kf(t) of the iron nanofluid at the upper of the container at different settling time (t=0, 1, 2, . . . , 89 h) and at 25° C. were measured by inserting the test probe into the measured sample from the top of the sample cell. Because the iron nanofluid is a much diluted solid-liquid two-phase mixture, and the susceptibility of the thermal conductivity enhancement rate to iron nanoparticles sedimentation is larger than that of the thermal conductivity to iron nanoparticles sedimentation. In order to improve the measurement precision, a term “enhancement rate α” is defined as a thermal conductivity enhancement rate having a calculation formula:

Enhancement rate α=(kf−kl)/kl,

where kf and kl are the thermal conductivities of the iron nanofluid and the base liquid silicone oil, respectively. A relationship (α−t) curve of the thermal conductivity enhancement rate vs. settling time was obtained by calculation based on the measured kf(t), as show in FIG. 17. When k is replaced with α, that is, substituting α for k in the formula v=dk/dt, v=Δk/Δt, SD(t)=((kt−k0)/k0)×100% and CSD(t)=(1−(kcss−kt)/kcss)×100%, the following formulas can be obtained: v=dα/dt and v=Δα/Δt, SD(t)=((αt−α0)/α0)×100%, and CSD(t)=(1−(αcss−αt)/αcss)×100%.

FIG. 17 indicates α0=2.75% and αt≈2.75% at settling time 0-23 hours. Obviously, the sedimentation rate v is zero in a range of settling time 0-23 hours (v=Δα/Δt=(2.75%−2.75%)/23=0); and the sedimentation degree SD (0-23 h) is also zero in a range of settling time 0-23 hours (SD(t)=((αt−α0)/α0)×100%=(2.75%−2.75%)/2.75%×100%=0). The αt is linearly decreased with the settling time in a range of 23-51 hours, the sedimentation rate v in a range of settling time 23-51 hours was figured out by linear fitting, the result was α(t)=−9.8×10⁻⁴×t+5.01×10⁻², and the slope is the sedimentation rate, that is v=−9.8×10⁻⁴ h⁻¹. The α(40 h) was equal to 1.00% at settling time t=40 hours, since the maximum and minimum thermal conductivity enhancement rates a are respectively corresponding to the no-sedimentation status and complete sedimentation status, i.e., the α0 is 2.75% and the αcss=0%, thus SD(40 h)=((α40 h−α0)/α0)×100%=(1.00%−2.75%)/2.75%×100%=−63.64%, the result showed that the thermal conductivity enhancement rate of iron nanofluid at settling time 40 h decreased 63.64% due to sedimentation. Further, all the at kept substantially unchanged and equal to be about 0% in a range of 51-90 hours, so the complete sedimentation degree CSD (51-90 h) is 100% in the range of settling time 51-90 hours.

In this manner, methods and apparatus for measuring sedimentation of a solid-liquid two-phase mixture are provided based on thermal conductivity variation of the solid-liquid two-phase mixture. The principle and the embodiments of the present invention are explained in combination with particular embodiments, which are intended to help understand the method and the core concept of the present invention.

The embodiments disclosed herein are exemplary only. Other applications, advantages, alternations, modifications, or equivalents to the disclosed embodiments are obvious to those skilled in the art and are intended to be encompassed within the scope of the present disclosure.

What is claimed is:

1. A method for measuring sedimentation of a solid-liquid two-phase mixture, comprising:
providing the solid-liquid two-phase mixture to be measured;
providing one or more of a standard work curve and a standard mathematical model, wherein each of the standard work curve and the standard mathematical model provides a relationship between a thermal conductivity (k) and a concentration (φ) or a relationship between a thermal conductivity (k) and a density (ρ);
measuring a thermal conductivity (k) of a sediment in the solid-liquid two-phase mixture to be measured at each of a plurality of settling times (t) to obtain a relationship curve (k−t);
converting the relationship curve (k−t) into a relationship curve (φ−t) or a relationship curve (ρ−t) or both, based on the one or more of the standard work curve and the mathematical relationship; and determining a concentration (φ) or a density (ρ) of the solid-liquid two-phase mixture to be measured, based on the measured thermal conductivity (k) at each of the plurality of settling times (t);
determining a sedimentation rate of the solid-liquid two-phase mixture to be measured according to a variation rate of one or more of the thermal conductivity, the concentration, and the density; and
determining one or more of a sedimentation status, a sedimentation degree, and a complete sedimentation degree according to one or more of a variation degree of the thermal conductivity (k), the concentration (φ) and the density (ρ) of the solid-liquid two-phase mixture to be measured.

2. The method according to claim 1, wherein: the sedimentation rate is determined by calculating the variation rate of the thermal conductivity (k) over the settling time (t) during sedimentation, and wherein the sedimentation rate is determined by dk/dt or Δk/Δt.

3. The method according to claim 1, wherein the sedimentation rate is determined by calculating a variation rate of the concentration (φ) over the settling time (t) during sedimentation, and wherein the sedimentation rate is determined by dφ/dt or Δφ/Δt.

4. The method according to claim 1, wherein the sedimentation rate is determined by calculating a variation rate of the density (ρ) over the settling time (t) during sedimentation, and wherein the sedimentation rate is determined by dρ/dt or Δρ/Δt.

5. The method according to claim 1, wherein the sedimentation status is determined by kt of the thermal conductivity (k) of the sediment in the solid-liquid two-phase mixture to be measured at a settling time (t).

6. The method according to claim 1, wherein the sedimentation status is determined by φt of the concentration (φ) of the sediment in the solid-liquid two-phase mixture to be measured at a settling time (t); or by pt of the density (ρ) of the sediment in the solid-liquid two-phase mixture to be measured at a settling time (t).

7. The method according to claim 1, wherein the sedimentation degree SD(t) at a settling time t is determined by SD(t)=((kt−k0)/k0)×100%, wherein kt is the thermal conductivity measured at the settling time t, and k0 is the thermal conductivity measured at the settling time to.

8. The method according to claim 1, wherein the sedimentation degree SD(t) at a settling time t is determined by SD(t)=((ρt−ρ0)/ρ0)×100%, wherein ρt is the concentration measured at the settling time t, and ρ0 is the concentration measured at the settling time t0.

9. The method according to claim 1, wherein the sedimentation degree SD(t) at a settling time t is determined by SD(t)=((ρt−ρ0)/ρ0)×100%, wherein ρt is the density measured at the settling time t, and ρ0 is the density measured at the settling time t0.

10. The method according to claim 1, wherein the complete sedimentation degree CSD(t) is determined by CSD(t)=(1−(kcss−kt)/kcss)×100%, wherein kt is the thermal conductivity of the sediment measured at a settling time (t=t), and kcss is the thermal conductivity of the sediment measured at a complete sedimentation status (t→∞).

11. The method according to claim 1, wherein the complete sedimentation degree CSD(t) is determined by CSD(t)=(1−(φcss−kt)/φcss)×100%, wherein φt is the concentration of the sediment measured at a settling time (t=t), and φcss is the concentration of the sediment measured at a complete sedimentation status (t→∞).

12. The method according to claim 1, wherein the complete sedimentation degree CSD(t) is determined by CSD(t)=(1−(ρcss−ρt)/ρcss)×100%, wherein ρt is the density of the sediment measured at a settling time (t=t), and ρcss is the density of the sediment measured at a complete sedimentation status (t→∞).

13. The method according to claim 1, wherein the step of providing one or more of the standard work curve and the standard mathematical model includes:
preparing a set of solid-liquid two-phase mixtures as standard samples, wherein the solid-liquid two-phase mixture to be measured corresponds to the set of solid-liquid two-phase mixtures;
measuring a thermal conductivity (k) of each of the set of solid-liquid two-phase mixtures;
measuring one or more of a concentration (φ) and a density (ρ) of each of the set of solid-liquid two-phase mixtures;
preparing the standard work curve for a relationship between the thermal conductivity (k) and the concentration (φ) or a relationship between the thermal conductivity (k) and the density (ρ); and
preparing the standard mathematical model k=f(φ) between the thermal conductivity (k) and the concentration (φ) or standard mathematical model k=f(ρ) between the thermal conductivity (k) and the density (ρ).

14. An apparatus for measuring sedimentation of a solid-liquid two-phase mixture, comprising:
a first unit, a second unit, and a third unit, wherein:
the first unit includes a test probe configured to produce a precise amount of heat and measure a temperature transient at a plurality of different heights from a bottom of a sediment of the solid-liquid two-phase mixture to be measured, for the second unit to process to obtain a thermal conductivity,
the second unit is configured to determine a measurement condition and procedure of the first unit, and process a signal from the first unit and determine a sedimentation rate, a sedimentation status, a sedimentation degree, and a complete sedimentation degree of the sedimentation of the solid-liquid two-phase mixture to be measured, and
the third unit is configured to display or transmit results sent from the second unit; and wherein:
the first unit further includes a sample cell, a temperature control system, an adjustable heating power, and a power supply unit, wherein the test probe is configured in the sample cell and the temperature control system is configured to control a temperature of the solid-liquid two-phase mixture contained in the sample cell,
the second unit includes a signal amplifier connected to the test probe, a filter connected to the signal amplifier, and an analog to digital conversion (ADC) module connecting the filter and a micro control unit (MCU), wherein an input module, a storage unit, and a power supply unit are all connected to the MCU, and
the third unit includes one or more of the storage unit, a communication unit, a display unit, a printing unit, and the power supply unit.

15. The apparatus according to claim 14, wherein the first unit is configured to measure the temperature transient of a sediment in the solid-liquid two-phase mixture to be measured at each of a plurality of settling times for the second unit to determine temperature transient and a thermal conductivity (k) averaged from thermal conductivities at the plurality of heights in the sediment for each settling time, and to obtain a relationship curve (k−t) between the thermal conductivity and the settling time.

16. The apparatus according to claim 14, wherein the second unit is configured to collect and process of a signal including the temperature transient sent from the first unit; to calculate to obtain the thermal conductivity at each of a plurality of settling times and to obtain a thermal conductivity at each settling time, and to plot out a relationship curve (k−t); and to convert the relationship curve (k−t) into one or more of a relationship curve (φ−t) and (ρ−t) based on one or more of a standard work curve and a mathematical relationship between the thermal conductivity and each of one or more of a concentration and a density.

17. The apparatus according to claim 14, wherein the micro control unit is configured to further determine a sedimentation rate by calculating a variation rate of the thermal conductivity (dk/dt or Δk/Δt), or a variation rate of the concentration (dφ/dt or Δφ/Δt), or a variation rate of the density (dρ/dt or Δρ/Δt) within a given settling time range (t1-tn); and to determine the sedimentation status, a sedimentation degree, and a complete sedimentation degree of the sedimentation of the solid-liquid two-phase mixture to be measured, by calculating the variation rate of the thermal conductivity (dk/dt or Δk/Δt), or the variation rate of the concentration (dφ/dt or Δφ/Δt), or the variation rate of the density (dρ/dt or Δρ/Δt) within the given settling time range (t1-tn).

18. The apparatus according to claim 14, wherein the adjustable heating power is connected to a line-source heater of the test probe, the signal amplifier is connected to the multiple temperature sensors of the test probe via multiplexer; wherein the input module, the storage unit, the communication unit, the display unit, and the printing unit are connected with the micro control unit; and wherein the power supply unit is connected to the adjustable heating power and the micro control unit.

19. The apparatus according to claim 14, wherein the test probe of the first unit includes a single sleeve structure, wherein the single sleeve structure includes a metal sleeve, a line-source heater, a multiple temperature sensors, an insulating materials and a multiplexer, wherein the line-source heater produces the precise amount of heat, the multiple temperature sensors measure the temperature transient, wherein the line-source heater is enclosed and fixed in the metal sleeve by filling with an insulating material having a high thermal conductivity, and the multiple temperature sensors are enclosed in the metal sleeve and equally spaced at three positions or more along a length of the metal sleeve.

20. The apparatus according to claim 14, wherein the test probe of the first unit includes a double sleeve structure, wherein the double sleeve structure includes a first metal sleeve, a second metal sleeve, a line-source heater, multiple temperature sensors, an insulating materials, and a multiplexer, wherein the line-source heater and the insulating material are encapsulated in the first metal sleeve, and the multiple temperature sensors and the insulating material are encapsulated in the second metal sleeve, the multiple temperature sensors are equally spaced at three positions or more along a length of the second metal sleeve.
